(19) United States
(12) Patent Application Publication
(10) Pub. No.: US 2025/0263279 A1
(43) Pub. Date: Aug. 21, 2025

(54) SYSTEMS AND METHODS FOR AN EXTENDED SIDE-SHIFT ASSEMBLY FOR HANDLING PALLETS

(71) Applicant: Fox Robotics, Inc., Austin, TX (US)

(72) Inventors: Peter Anderson-Sprecher, Austin, TX (US); Omar Alvi, Austin, TX (US); Vaibhav Shete, Austin, TX (US)

(21) Appl. No.: 19/060,329

(22) Filed: Feb. 21, 2025

Related U.S. Application Data
(60) Provisional application No. 63/556,144, filed on Feb. 21, 2024.

(51) Int. Cl. B66F 9/14; B66F 9/06; B66F 9/075

(52) U.S. Cl. CPC B66F 9/144; B66F 9/0755; B66F 9/063

(57) ABSTRACT

The present invention relates, in general, to systems and methods for controlling autonomous forklifts, and specifically, for extending a lateral range of motion and side shifting ability for a load handling assembly. The present invention allows for independent control and lateral actuation of a backplate mounted on a fixed carriage, as well as independent control and lateral actuation of right and left forks mounted on the backplate.

### BACKGROUND

### Field of the Invention

The present invention relates, in general, to an extended side-shift assembly for an autonomous vehicle that facilitates the loading and unloading of tail-adjacent pallets on a trailer and other shipping containers.

### Description of Related Art

One of the key challenges for autonomous vehicles, such as autonomous forklifts, operating in warehouse and/or loading dock environments is in picking a first row of pallets in a trailer which are not directly in front of a dock leveler. Particularly in the case of recessed dock levelers or vertical style levelers with side barriers, getting the forks in a position to cleanly extract the first row of pallets is a significant challenge. This is made increasingly difficult by the fact that autonomous forklifts are typically outfitted with additional sensors that widen the overall footprint of the vehicle.

Forklifts are typically outfitted with a side-shift assembly, which operates by moving a backplate relative to a carriage mounted on the vehicle frame. Forks are then affixed to the backplate, yielding an assembly that can move the forks relative to the forklift body, helping with handling objects located adjacent to walls. The geometry of the backplate and carriage assembly is such that due to technical constraints, they must be the same width, and the degree of shift is limited to some fraction of this width. This constraint poses a challenge for handling objects far to the side of the forklift, as is the case in tail-adjacent pallets, as the backplate size may not exceed the width of the pallet to be picked, which have dimensions of 48″×40″ for a standard Grocery Manufacturers Association (GMA) pallet.

Conventional side-shift assemblies for forklifts do not allow for independent positioning of each fork, as well as independent positioning of the backplate. Rather, existing side-shift assemblies allow for only narrowing or spreading the forks, where both forks are always adjusted simultaneously either towards each other (i.e. narrowing operations) or away from each other (i.e. spreading operations).

Thus, there is a need for a modified side-shift assembly that overcomes the aforementioned challenges, and which utilizes a combination of independent backplate and fork positioning to yield an increased range of motion suitable for extended side-shift applications, including, but not limited to, handling of tail-adjacent pallets.

### SUMMARY

In an embodiment, the present invention is directed to a side-shift assembly for a forklift, comprising: a carriage mounted on the forklift; a backplate mounted on the carriage, the backplate capable of lateral adjustment relative to the carriage; and a fork assembly mounted on the backplate, wherein the fork assembly includes a first fork and a second fork, each of the first fork and the second fork capable of independent lateral adjustment relative to the backplate.

In another embodiment, the present invention is directed to a side-shift assembly for a forklift, comprising: a carriage mounted on the forklift; a backplate coupled to the carriage, the backplate capable of lateral adjustment relative to the carriage; a backplate actuator coupled to the backplate, the backplate actuator configured to provide driving force to adjust the backplate; a fork assembly mounted on the backplate, wherein the fork assembly includes a first fork and a second fork, each of the first fork and the second fork capable of independent lateral adjustment relative to the backplate; a fork actuator coupled to the first fork and the second fork, the fork actuator configured to provide driving force to independently adjust the first fork and the second fork; and a controller communicatively coupled to the backplate actuator and the fork actuator.

In yet another embodiment, the present invention is directed to a side-shift assembly for a forklift, comprising: a carriage mounted on the forklift; a backplate coupled to the carriage, the backplate capable of lateral adjustment relative to the carriage; a backplate actuator coupled to the backplate, the backplate actuator configured to provide driving force to adjust the backplate; a fork assembly mounted on the backplate, wherein the fork assembly includes a first fork and a second fork, each of the first fork and the second fork capable of independent lateral adjustment relative to the backplate, and each of the first fork and the second fork capable of independent lateral adjustment relative to one another; a fork actuator coupled to the first fork and the second fork, the fork actuator configured to provide driving force to independently adjust the first fork and the second fork; and a controller communicatively coupled to the backplate actuator and the fork actuator.

### BRIEF DESCRIPTION OF THE DRAWINGS

These and other embodiments of the present invention will be discussed with reference to the following exemplary and non-limiting illustrations, in which like elements are numbered similarly, and where:

FIGS. 1A and 1B depict an autonomous forklift, according to an embodiment of the present invention;

FIG. 2 is a block diagram of a side-shift adjustment system, according to an embodiment of the present invention;

FIG. 3 is a diagram of a side-shift assembly, according to an embodiment of the present invention;

FIG. 4 is a diagram of an adjusted side-shift assembly, according to an embodiment of the present invention;

FIG. 5 is a flowchart illustrating the steps of operation of the side-shift adjustment system during a pallet picking maneuver, according to an embodiment of the present invention; and

FIG. 6 is a flowchart illustrating the steps of operation of the side-shift adjustment system during a pallet placing maneuver, according to an embodiment of the present invention.

### DEFINITIONS

The following definitions are meant to aid in the description and understanding of the defined terms in the context of the present invention. The definitions are not meant to limit these terms to less than is described throughout this specification. Such definitions are meant to encompass grammatical equivalents.

As used herein, the term “autonomous forklift” can refer to, for example, autonomous mobile robots, automatic guided vehicles, vision guided vehicles, semi-autonomous vehicles, and remote-piloted autonomous vehicles, as examples, which serve as equipment, pallet, object, and cargo moving and transport vehicles, including, but not limited to, fork trucks, pallet loaders, side loaders, lift trucks, fork hoists, stacker-trucks, trailer loaders, industrial trucks, pallet jacks, pallet stackers, tow tractors, tugs, and the like.

As used herein, the terms “sensor” and “detector” can refer to, for example, sensing technologies that utilize Light Detection and Ranging (LiDAR), laser scanners, range finders, radar, infrared sensors, sonar, ultrasonic sensors, optical sensors, such as photoelectric sensors, fiber optic sensors, photoconductive devices, reflective sensors, phototransistors, ambient light sensors, infrared sensors, photodiodes, and optical switches, point sensors, proximity sensors, through beam sensors, light curtains, image and video capturing devices, machine vision systems, any combination thereof, and the like.

As used herein, the term “inertial measurement unit” and “IMU” can refer to, for example, accelerometers, gyroscopes, magnetometers, pressure sensors, any combination thereof, and the like.

As used herein, the term “network” can refer to, for example, the Internet, a wide area network (WAN), metropolitan area network (MAN), controller area network (CAN), local area network (LAN), but the network could at least theoretically be of an applicable size or characterized in some other fashion (i.e., personal area network (PAN), home area network (HAN), and the like), a wireless network, a wireless mesh network, a cellular network, a landline network, and/or a short-range connection network (i.e., such as Bluetooth, Zigbee, infrared, and the like). The term “network” can further refer to enterprise private networks, edge networks, and/or virtual private networks.

As used herein, the term “processor” can refer to, for example, any programmable system including systems using micro-controllers, reduced instruction set circuits (RISC), application specific integrated circuits (ASICs), logic circuits, and any other circuit or processor capable of executing the functions described herein. The above examples are exemplary only and are thus not intended to limit in any way the definition and/or meaning of the term “processor.”

As used herein, the terms “software” and “firmware” are interchangeable, and can refer to, for example, any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

As used herein, the term “database” can refer to, for example, a persistent data store with indexing capabilities to expedite query processing. The database can implement various database management system types such as relational, object-oriented, hierarchical, document-oriented, flat file, object-relational, and any other structured collection of records. The database can be stored locally, remotely, on a cloud environment, and/or on a distributed ledger.

As used herein, the term “actuator” can refer to, for example, a machine that creates motion, and includes electric actuators such as electric motors, electric linear actuators, stepper motors, and jack screws, hydraulic actuators such as hydraulic cylinders and hydraulic motors, pneumatic actuators, mechanical actuators such as ball screws, leadscrews, rack and pinion, and cams, piezoelectric actuators, and electromagnetic actuators.

As used herein, the term “artificial intelligence” can refer to, for example, machine learning, deep-learning, supervised learning, unsupervised learning, semi-supervised learning, generative artificial intelligence, reinforced learning, fuzzy logic, neural networks, historical data and pattern analysis, any combination thereof, and the like.

As used herein, the term “module” can refer to, for example, hardware components, software components, such as source code, packages, libraries, algorithms, and the like, as well as combinations therein.

As used herein, the term “bump sensor” can refer to, for example, a bump switch, bumper switch, push-button switch, snap-action switch, limit switch, touch switch, and the like, which provides a signal indicating whether the autonomous forklift is in contact with, or receiving resistance from, an obstacle.

### DETAILED DESCRIPTION

It should be understood that aspects of the present invention are described herein with reference to the figures, which show illustrative embodiments. The illustrative embodiments herein are not necessarily intended to show all embodiments in accordance with the invention but rather are used to describe a few illustrative embodiments. Thus, aspects of the invention are not intended to be construed narrowly in view of the illustrative embodiments. In addition, although the present invention is described with respect to its application for an autonomous forklift operating in a loading dock environment, it is understood that the system could be implemented in any autonomous or semi-autonomous vehicle system operating in any environment where pallets are handled, such as shipping docks, shipping containers, and other storage facilities and containers.

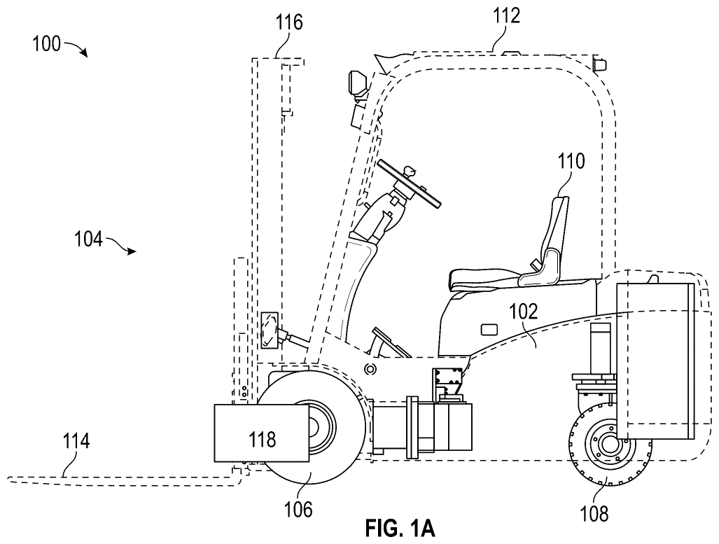

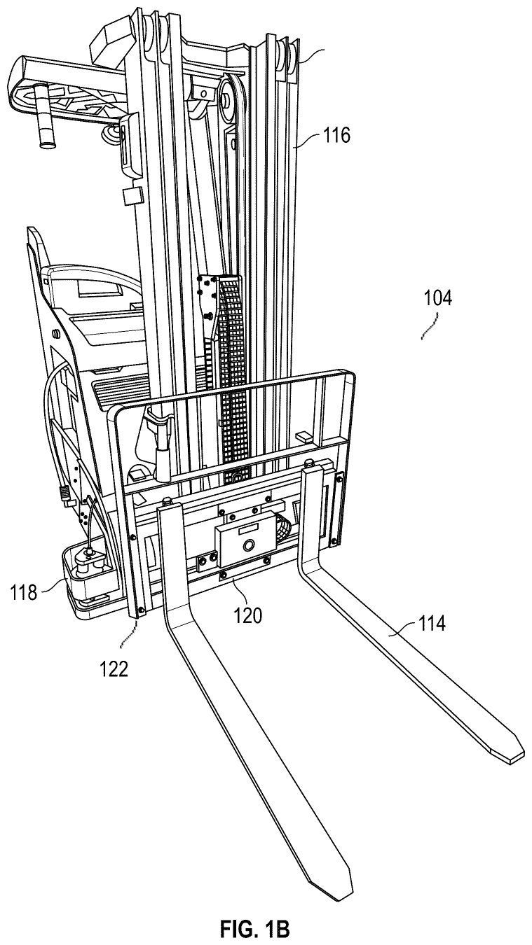

FIGS. 1A and 1B depict an autonomous forklift 100, according to an embodiment of the present invention. The autonomous forklift 100 includes a body 102 and a load-handling system 104 that is coupled to the front of the body 102. An operator's compartment 110 can be provided in the center of the body 102. In one or more embodiments, an operator's compartment 110 may be installed to enable a manual or semi-autonomous operation of the autonomous forklift 100. Alternatively, in an embodiment, the autonomous forklift 100 may be fully autonomous, without the operator's compartment 110.

The body 102 stands on front drive wheels 106 and at least one rear wheel 108. Specifically, the front pair of wheels are drive wheels 106 and the rear wheel 108 is a steer wheel. The drive wheels 106 provide the power to move the autonomous forklift 100 forward or backwards. In an embodiment, the drive wheels 106 are a plurality of wheels that are mechanically coupled to a chassis of the autonomous forklift 100. The plurality of drive wheels 106 and the rear wheel 108 enable movement of the chassis along a ground surface. A motor is mechanically coupled to at least one wheel in the plurality of drive wheels 106. The motor can rotate the at least one wheel and turn the at least one wheel to slow and/or stop the autonomous forklift 100.

Further, the drive wheels 106 may move only in two directions (e.g., forward, and backward) or turn under a plurality of angles. Additionally, the rear wheel 108 may be responsible for changing the direction of the autonomous forklift 100.

In another embodiment, the rear wheel 108 may serve as a driving force provider, while the two front wheels 106 may serve as stabilizers.

The autonomous forklift 100 may be powered by an internal combustion engine, an electric motor, a fuel cell, or a combination thereof, such as in a hybrid powered vehicle. The body 102 may include an overhead guard 112 that covers the upper part of the operator's compartment 110.

Further, the load-handling system 104 includes a mast 116. The mast may include inner masts and outer masts, where the inner masts are slidable with respect to the outer masts. In an embodiment, the mast 116 may be movable with respect to the vehicle body 102. The movement of the mast 116 may be operated by hydraulic tilt cylinders positioned between the body 102 and the mast 116. The tilt cylinders may cause the mast 116 to tilt forward and rearward around the bottom end portions of the mast 116. Additionally, a pair of hydraulically operated lift cylinders may be mounted to the mast 116 itself. The lift cylinders may cause the inner masts to slide up and down vertically relative to the outer masts.

Further, a fork assembly 114 is mounted to the mast 116 through a lift bracket, which is slidable up and down vertically relative to the inner masts. In an embodiment, the inner masts, the fork assembly 114, and the lift bracket all provide a vertical lifting function. The load-handling system 104 also includes a side-shift assembly 122, allowing for accurate lateral (i.e., left and right horizontal) positioning of the fork assembly 114. In an embodiment, the side-shift actuation is performed by hydraulically actuated cylinders, in other embodiments it is driven by electric linear actuators.

Thus, the load-handling assembly 104 provides a horizontal shifting function of the fork assembly 114 (via the side-shift assembly 122), as well as a vertical lifting and lowering function of the fork assembly 114. In an embodiment, each fork can be laterally adjusted independent of the other fork, as described herein.

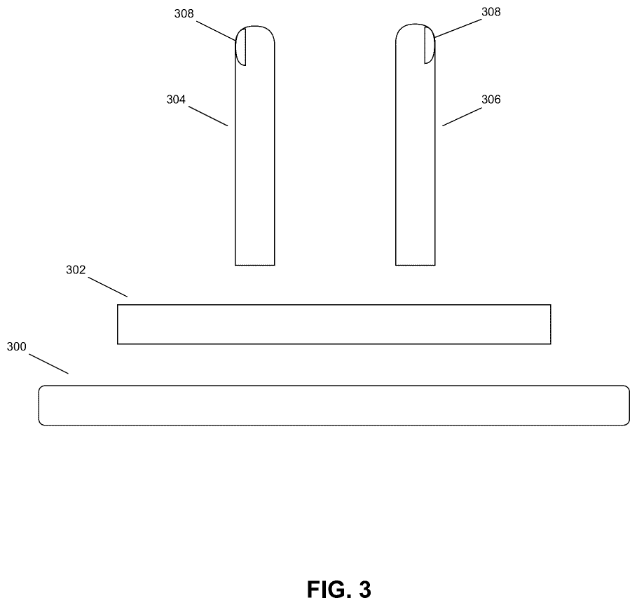

In an embodiment, the autonomous forklift 100 includes a sensor module 118, that includes a plurality of sensors, as well as at least one camera 120. In an embodiment, the sensor module 118 comprises just a camera or multiple cameras. In another embodiment, the sensor module 118 comprises just the LiDAR system 206. In yet another embodiment, the sensor module 118 comprises a combination of cameras, LiDAR, and other sensors. For example, the sensor module 118 can incorporate fork sensors 308, as described herein with reference to FIG. 3.

The autonomous forklift 100 is described in more detail in commonly owned application Ser. No. 18/480,214 entitled “Method and system for operating automated forklift”, filed on Oct. 3, 2023, and commonly owned application Ser. No. 18/410,774 entitled “Method and system for deep learning-based perception”, filed on Jan. 11, 2024, both of which are incorporated by reference herein.

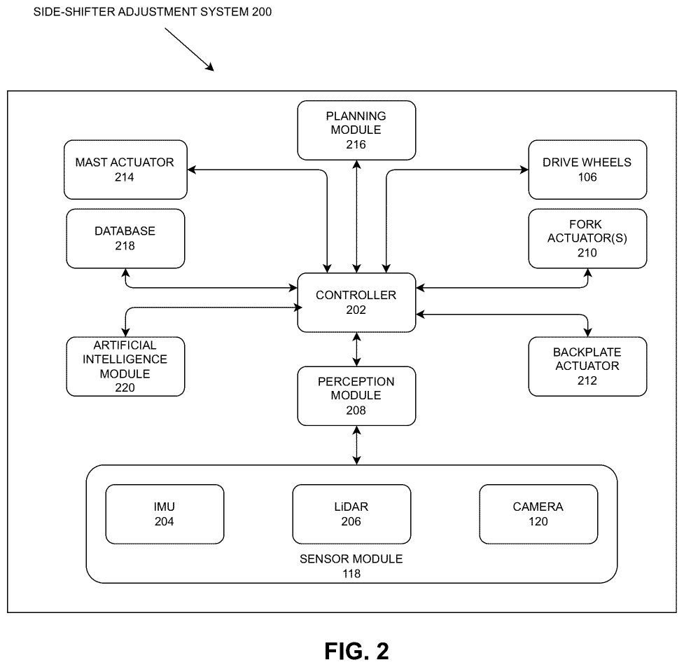

FIG. 2 is a block diagram of a side-shift adjustment system 200 for the autonomous forklift 100, according to an embodiment of the present invention. In an embodiment, the side-shift adjustment system 200 includes a controller 202 that is communicatively coupled to the sensor module 118, a perception module 208, at least one fork actuator 210, a backplate actuator 212, a mast actuator 214, and a planning module 216, via a network. The network may be any type of network suitable to allow interaction between the components of the side-shift adjustment system 200, such as a CAN bus on-board the autonomous forklift 100. In another embodiment, the network may be a wired network, a wireless network, a mesh network, or any combination thereof.

In an embodiment, the controller 202 consists of computing hardware, such as a processor, and software which is executed by the processor. In an exemplary embodiment the controller 202 is located on-board the autonomous forklift 100. In another embodiment, the controller 202 can include a server coupled to the network. In another embodiment, the controller 202 is cloud-based, and located on remote server, such as on a server provided by Google® Cloud Platform or the like. In yet another embodiment, the controller 202 can be distributed across multiple servers.

In an embodiment, the controller 202 receives input, such as data, from the sensor module 118, the perception module 208, the planning module 212, the fork actuator 210, the backplate actuator 212, the mast actuator 214, the drive wheels 106, the planning module 216, the database 218, and the artificial intelligence module 220, and provides output, such as commands to the fork actuator 210, backplate actuator 212, and the mast actuator 214.

In an embodiment, the sensor module 118 includes a plurality of sensors including, at least an IMU 204, a LiDAR system 206, and/or at least one camera 120.

In an embodiment, the IMU 204 combines a plurality of sensors (e.g., accelerometer, gyroscope, magnetometer, pressure sensor . . . ) to provide data regarding the orientation, acceleration, and angular velocity of the autonomous forklift 100. More specifically, an accelerometer of the IMU 204 may measure linear acceleration to determine changes in velocity and direction. Further, a gyroscope of the IMU 204 may measure rotational movements and the magnetometer detects the Earth's magnetic field and to determine orientation information as well as the angle of tilt of the autonomous forklift 100.

In an embodiment, the IMU 204 can be communicatively coupled to the drive wheels 106 and/or the load-handling assembly 104 and can receive signals therefrom. The IMU 204 can collect, for example, information related to speed, velocity, orientation, angular rates, direction, gravitational forces, wheel rotation, and the like, of the drive wheels 106.

Furthermore, the IMU 204 can collect, for example, information related to the weight or load carried, lateral and vertical adjustments of each fork, tilt of the fork assembly 114, and the like.

In an embodiment, the camera 120 may be a stereoscopic camera (also known as a stereo or 3D camera), a time-of-flight (ToF) camera or sensor, line scan or area scan camera, a CCD camera, a CMOS camera, or any other suitable camera used in robotics. The camera 120 may capture images in monochrome or in color. Physically, the camera 120 may be located on the front side of the autonomous forklift 100, such as on the backplate 302 shown in FIG. 3, to be able to capture the position of the fork assembly 114, as well as the surrounding environment that faces the forward movement direction of the autonomous forklift 110. Additionally, there may be one or more cameras disposed on the autonomous forklift 100, such as a camera array and/or multiple cameras located at various locations on the autonomous forklift 100, such as to provide a 360-degree field of view around the autonomous forklift 100. In an embodiment, the camera 120 captures image data and video data.

In an embodiment, the LiDAR system 206 is mounted on the carriage 300 shown in FIG. 3. The LiDAR system 206 can provide distance estimation of obstacles and objects, as well as facilitate object recognition by the perception module 208.

The use of the IMU 204, the LiDAR system 206, and the camera 120 in the sensor module 118 is exemplary, and are not intended to be a limiting. The sensor module 118 can include various other sensing or detecting devices as described herein.

In an embodiment, the perception module 208 receives visual data from the sensor module 118 that is collected as the autonomous forklift 100 traverses an environment. The visual data can include, for example, a collection of low- and high-resolution video frames and/or images, including but not limited to one or more (e.g., monocular or stereo) color or grayscale light intensity images, 3D depth images, and derived images such as 2D or 3D traversability maps, or sets of features recognized within the visual data.

The perception module 208 performs object recognition on the visual data and determines if obstacles are present in the visual data. If an obstacle is detected in the visual data, the perception module 208 classifies each obstacle, such as, for example, as a human, a pallet, a wall, a vehicle, a trailer, and the like.

In an embodiment, the perception module 208 determines dimensions of objects, such as a pallet, as well as dimensions of obstacles which may need to be cleared by the autonomous forklift 100 when loading/picking, carrying, or unloading/placing the pallet.

In an embodiment, the planning module 216 generates a plan for placing or inserting the pallet carried by the autonomous forklift 100 based on the dimensions of the pallet as well as the dimensions of any detected obstacles.

In an embodiment, the database 218 is configured to store various data, receive queries from the controller 202, and return data to the controller 202 in response to the queries. The database 106 can store visual data collected by the sensor module 118, data processed by the perception module 208, data collected from the drive wheels 106, data collected from the fork actuator 210 and the backplate actuator 212, and/or relevant information generated by the planning module 216.

For example, the database 218 can store data collected by the sensors module 118 related to motion, navigation, speed, and trajectory of the autonomous forklift, as well as detected obstacles, collision avoidance maneuvers undertaken, and work performed such as picking and placing operations of pallets.

In an embodiment, the data in the database 218 is stored with an identifier related to at least one of a carried pallet, the autonomous forklift, a loading location, a placement location and/or any combination thereof. In addition, the data in the database 218 can be stored with timestamps.

This data may be stored locally within a database on the autonomous forklift 100, and can be transmitted to the controller 202, which can process the data, and further transmit data from the sensor module 118, planning module 216, and other sensors on the autonomous forklift 100, to the database 218 for storage and subsequent retrieval.

In another embodiment, all or portion of the data can be stored remotely on a remote database which is accessible by the controller 202.

In an embodiment, the artificial intelligence module 220 is communicatively coupled to the controller 202 and/or the database 218. The artificial intelligence module 220 can analyze data collected and generated over time by the sensor module 118, the perception module 208, the fork actuator 210, the backplate actuator 212, the planning module 216, and/or the drive wheels 106. This analysis by the artificial intelligence module 220 allows the controller 202 to process the future data more efficiently, quickly generate commands, and improve the efficacy and accuracy of the side-shift adjustment system 200.

For example, the artificial intelligence module 220 can analyze historical side-shift operations for a particular trailer and use the historical data to suggest a side-shift adjustment plan for a current picking or placement operation, or a subsequent picking or placement operation.

FIG. 3 is a diagram of a side-shift assembly 122, according to an embodiment of the present invention. In an embodiment, the side-shift assembly 122 includes a carriage 300. The carriage 300 can be mounted on the mast 116 and is configured to be adjusted vertically relative to the vehicle body 102.

In an embodiment, a backplate 302 is moveably mounted on the carriage 300. The backplate 302 can move in two directions laterally along a horizontal plane relative to the carriage 300. In an embodiment, the backplate 302 is mounted to the carriage 300 via at least one rail, where the mounting allows lateral movement of the backplate 302 along the rail. In an embodiment, the backplate actuator 212 (not depicted in FIG. 3) provides driving force to move the backplate 302 along the rail.

In an embodiment, the fork assembly 104 includes a right fork 304 and left fork 306, which are both moveably mounted on the backplate 302. In an embodiment, each fork 304, 306 can independently move in two directions laterally along a horizontal plane relative to the backplate 302. In an embodiment, each fork 304, 306 is mounted to the backplate 302 via a respective rail, where the mounting allows lateral movement of each fork 304, 306 along its respective rail. The fork actuator 210 (not depicted in FIG. 3) provides driving force to move each fork 304, 306 along the rail.

In another embodiment, each fork 304, 306 is mounted on a single rail. In yet another embodiment, the backplate actuator 212 and the fork actuator 210 can be a single actuator that provides driving force to the backplate 302 and each of the forks 304, 306.

In an embodiment, the forks 304, 306 have a rounded distal end, which prevents damaging or stabbing of soft obstacles or objects loaded on pallets.

In an embodiment, each fork 304, 306 is coupled to an independent fork actuator. In another embodiment, a single fork actuator is coupled to both forks 304, 306. Each fork 304, 306 can be independently moved such that the fork 304 can be positioned while the fork 306 remains stationary, and vice versa. Furthermore, each fork 304, 306 can be independently moved to different degrees, such that the fork 304 can be moved laterally a greater distance than fork 306, and vice versa.

Thus, the side-shift assembly 122 of the present invention utilizes a combination of backplate 302 and fork 304, 306 positioning to yield an increased range of lateral range of motion suitable for extended shift applications, such as loading and unloading pallets near the tail of a trailer and other shipping containers. In an embodiment, the backplate 302 can be adjusted laterally relative to the carriage 300, while one or more forks 304, 306 can be independently adjusted laterally relative to the backplate 302. The side-shift assembly 122 facilitates picking pallets narrower than the width of the backplate 302, as well as placing pallets in confined spaces.

Furthermore, the side-shift assembly 122 allows for the picking of various sized pallets, in addition to standard GMA pallets, such as varying sized stringer pallets and European pallets which can have dimensions of 31.5″×47.2″. The side-shift assembly 122 supports the transporting of a wide range of pallet types, as the independent adjustment of the backplate 302 and forks 304, 306 provides variable spacing to accommodate the picking of different sized pallets.

In an embodiment, each fork 304, 306 includes a respective fork sensor 308 mounted at a distal end of each fork 304, 306. The fork sensor 308 is preferably mounted at an outer edge of each fork 304, 306. In an embodiment, the fork sensor 308 comprises a robotic vision system that includes a stereo depth camera and a high-resolution camera, such as an OAK-D camera manufactured by Luxonic Inc. In an embodiment, the fork sensor 308 includes multiple robotic vision systems, cameras, and/or sensors which are stacked on top of one another about the outer edge of each fork 304, 306.

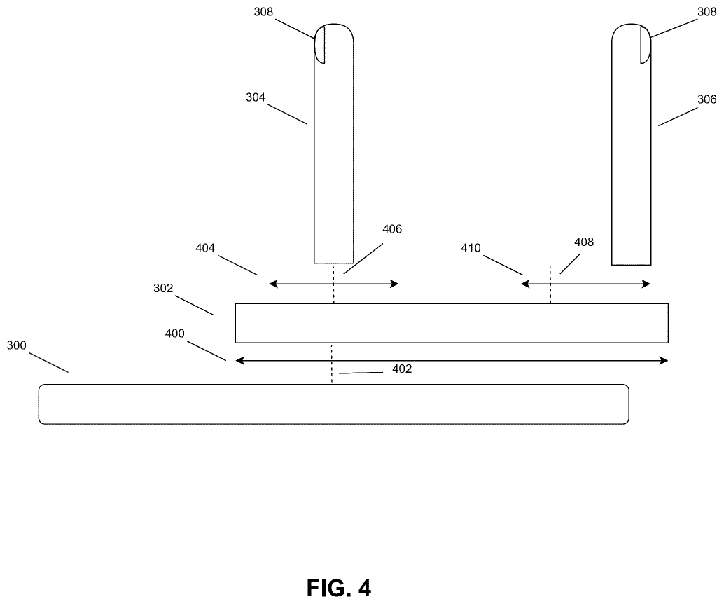

FIG. 4 is a diagram of an adjusted side-shift assembly 122, according to an embodiment of the present invention. As shown in FIG. 4, the backplate 302 has been shifted toward the left along the axis 400 relative to a centerline 402 of the backplate 302, and relative to the carriage 300. In addition, the left fork 306 has been shifted toward the left along the axis 410 relative to a centerline 408 of the left fork, and relative to the backplate 302. The right fork 304 remains at its centerline 406 and has not been adjusted along its axis 404. The laterally adjusted backplate 302 and left fork 306 shown in FIG. 4 is merely exemplary, and numerous combinations of adjustments of the backplate 302 and forks 304, 306 can be achieved by the present invention.

The side-shift assembly 122 allows for independent lateral adjustment of the backplate 302 relative to the carriage 300 and further allows for independent lateral adjustment of each fork 304, 306 relative to one another, as well as to the backplate 302 and the carriage 300.

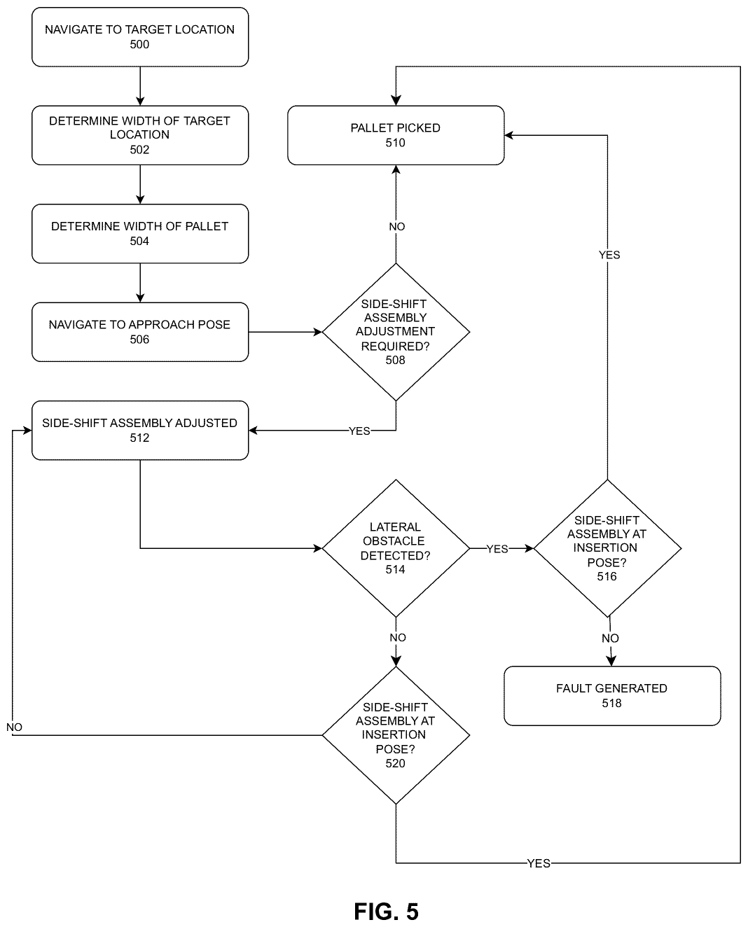

FIG. 5 is a flowchart illustrating the steps of operation of the side-shift adjustment system 200 during a pallet picking maneuver, according to an embodiment of the present invention. At step 500, the autonomous forklift 100 navigates to a target location where a pallet is located.

At step 502, the perception module 208 determines the width of the target location. In an embodiment, the target location can be, for example, a trailer which the pallet is located in. The perception module 208 determines the width of the target location by using at least one of the sensor module 118 and the sensors 308 on the forks 304, 306. Furthermore, the perception module 208 determines a lateral clearance between the autonomous forklift 100 and the width of the target location, which can account for obstacles such as side walls, barriers, posts, and the like.

Next, at step 504, the perception module 208 determines the width of the pallet using at least one of the sensor module 118 and the fork sensors 308.

At step 506, the controller 202 utilizes the detected width of the target location, the lateral clearance, and the width of the pallet to navigate the autonomous forklift 100 to an approach pose, where the approach pose is a safe minimum distance within the lateral clearance where the autonomous forklift 100 can safely adjust the side-shift assembly 122 as needed to complete the pallet picking operation.

At step 508, the controller 202 determines if the side-shift assembly 122 requires adjustment to safely pick the pallet. If the backplate 302 and/or forks 304, 306 are at an insertion pose (i.e., the side-shift assembly 122 is optimally positioned to safely pick the pallet), then the process continues to step 510 where the controller 202 manipulates the drive wheels 106 such that the forks 304, 306 are inserted into the pallet, thereby picking the pallet from the target location.

However, if at step 508, the controller 202 determines that the side-shift assembly 122 requires adjustment to perform the pallet picking operation, then at step 512, the controller 202 adjusts the backplate 302, the right fork 304, and/or the left fork 306 to the required insertion pose. As described herein, the backplate 302, the right fork 304, and the left fork 306 can each be independently manipulated to achieve the required insertion pose.

At step 514, as the side-shift assembly 122 is being adjusted, the perception module 208 determines if the side-shift assembly 122 is approaching a lateral obstacle, such as wall or post of the trailer door, for example. In an embodiment, the perception module 208 utilizes the fork sensors 308 to determine if either fork 304, 306 is approaching a lateral obstacle as the backplate 302 and/or forks 304, 306 are being adjusted.

In an embodiment, the backplate 302 also includes backplate sensors (not depicted) on its lateral sides. The perception module 308 can also utilize the backplate sensors to determine if the backplate is approaching a lateral obstacle as it is being adjusted.

In yet another embodiment, the forks 304, 306 and/or the backplate 302 can include at least one bump sensor on, for example, the distal and/or lateral edges or sides. When the bump sensor contacts a lateral obstacle, the controller 202 receives a signal indicating lateral resistance.

If a lateral obstacle is detected at step 514, then the process continues step 516 where the controller 202 determines if the side-shift assembly 122 is at the required insertion pose. If the side-shift assembly 122 is not at the required insertion pose, then a fault is generated at step 518, and a human operator may be notified and prompted to intervene so that the autonomous forklift 100 can be safely maneuvered to the required insertion pose.

If, however, the side-shift assembly 122 is at the required insertion pose at step 516, then the process continues to step 510 where the controller 202 manipulates the drive wheels 106 such that the forks 304, 306 are inserted into the pallet, thereby picking the pallet from the target location.

If a lateral obstacle is not detected however at step 514, then the process continues to step 520 where the controller 202 determines if the side-shift assembly 122 is at the required insertion pose. If the controller 202 determines that the side-shift assembly 122 is not at the required insertion pose, then the process returns to step 512 where the side-shift assembly 122 continues to be adjusted.

If, however, the side-shift assembly 122 is at the required insertion pose at step 520, then the process continues to step 510 where the controller 202 manipulates the drive wheels 106 such that the forks 304, 306 are inserted into the pallet, thereby picking the pallet from the target location.

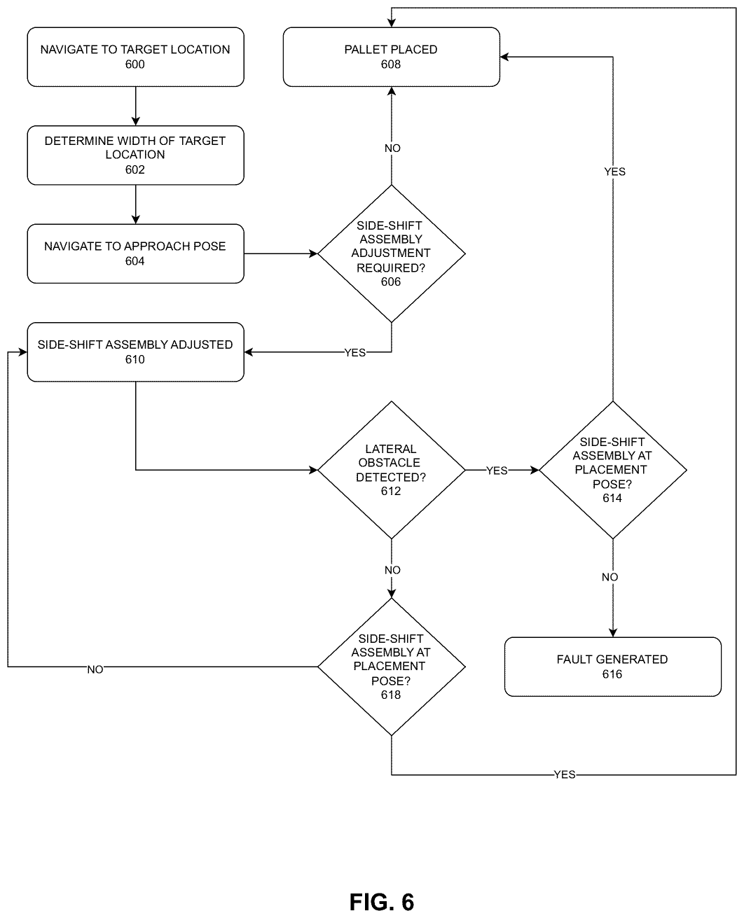

FIG. 6 is a flowchart illustrating the steps of operation of the side-shift adjustment system 200 during a pallet placing maneuver, according to an embodiment of the present invention. At step 600, the autonomous forklift 100 navigates to a target location where a pallet is to be placed.

At step 602, the perception module 208 determines the width of the target location. In an embodiment, the target location can be, for example, a trailer which the pallet is to be placed. The perception module 208 determines the width of the target location by using at least one of the sensor module 118 and the sensors 308 on the forks 304, 306. Furthermore, the perception module 208 determines a lateral clearance between the autonomous forklift 100 and the width of the target location, which can account for obstacles such as side walls, barriers, posts, and the like.

At step 604, the controller 202 utilizes the detected width of the target location, the lateral clearance, and the width of the pallet to navigate the autonomous forklift 100 to an approach pose, where the approach pose is a safe minimum distance within the lateral clearance where the autonomous forklift 100 can safely adjust the side-shift assembly 122 as needed to complete the pallet placing operation.

At step 606, the controller 202 determines if the side-shift assembly 122 requires adjustment to safely place the pallet. If the backplate 302 and/or forks 304, 306 are at a placement pose (i.e., the side-shift assembly 122 is optimally positioned to safely place the pallet), then the process continues to step 608 where the controller 202 manipulates the drive wheels 106 such that the forks 304, 306 are removed from the pallet, thereby placing the pallet at the target location.

However, if at step 606, the controller 202 determines that the side-shift assembly 122 requires adjustment to perform the pallet placement operation, then at step 610, the controller 202 adjusts the backplate 302, the right fork 304, and/or the left fork 306 to the required placement pose. As described herein, the backplate 302, the right fork 304, and the left fork 306 can each be independently manipulated. Thus, the side-shift assembly 122 can independently adjust the backplate 302, the right fork 304, and/or the left fork 306 while supporting a load, such as a pallet.

At step 612, as the side-shift assembly 122 is being adjusted, the perception module 208 determines if the side-shift assembly 122 is approaching a lateral obstacle, such as wall or post of the trailer door, for example. In an embodiment, the perception module 208 utilizes the fork sensors 308 to determine if either fork 304, 306 is approaching a lateral obstacle as the backplate 302 and/or forks 304, 306 are being adjusted.

In an embodiment, the backplate 302 also includes backplate sensors (not depicted) on its lateral sides. The perception module 308 utilizes the backplate sensors to determine if the backplate is approaching a lateral obstacle as it is being adjusted.

In yet another embodiment, the forks 304, 306 and/or the backplate 302 can include at least one bump sensor on, for example, the distal and/or lateral edges or sides. When the bump sensor contacts a lateral obstacle, the controller 202 receives a signal indicating lateral resistance.

If a lateral obstacle is detected at step 612, then the process continues step 614 where the controller 202 determines if the side-shift assembly 122 is at the required placement pose. If the side-shift assembly 122 is not at the required placement pose, then a fault is generated at step 616, and a human operator may be notified and prompted to intervene so that the autonomous forklift 100 can be safely maneuvered to the required placement pose.

If, however, the side-shift assembly 122 is at the required placement pose at step 614, then the process continues to step 608 where the controller 202 manipulates the drive wheels 106 such that the forks 304, 306 are removed from the pallet, thereby placing the pallet at the target location.

If a lateral obstacle is not detected however at step 612, then the process continues to step 618 where the controller 202 determines if the side-shift assembly 122 is at the required placement pose. If the controller 202 determines that the side-shift assembly 122 is not at the required placement pose, then the process returns to step 610 where the side-shift assembly 122 continues to be adjusted.

If, however, the side-shift assembly 122 is at the required placement pose at step 618, then the process continues to step 608 where the controller 202 manipulates the drive wheels 106 such that the forks 304, 306 are removed from the pallet, thereby placing the pallet at the target location.

While the principles of the disclosure have been illustrated in relation to the exemplary embodiments shown herein, the principles of the disclosure are not limited thereto and include any modification, variation, or permutation thereof.

1. A side-shift assembly for a forklift, comprising:
a carriage mounted on the forklift;
a backplate mounted on the carriage, the backplate capable of lateral adjustment relative to the carriage; and
a fork assembly mounted on the backplate, wherein the fork assembly includes a first fork and a second fork, each of the first fork and the second fork capable of independent lateral adjustment relative to the backplate.

2. The side-shift assembly of claim 1, wherein the first fork and the second fork are mounted on a rail coupled to the backplate.

3. The side-shift assembly of claim 1, further comprising a backplate actuator coupled to the backplate, the backplate actuator configured to provide driving force to adjust the backplate.

4. The side-shift assembly of claim 1, further comprising a fork actuator coupled to the first fork and the second fork, the fork actuator configured to provide driving force to independently adjust the first fork and the second fork.

5. The side-shift assembly of claim 1, further comprising a first fork actuator coupled to the first fork, the first fork actuator configured to provide driving force to adjust the first fork, and a second fork actuator coupled to the second fork, the second fork actuator configured to provide driving force to adjust the second fork.

6. The side-shift assembly of claim 1, wherein each of the first fork and the second fork are capable of being independently adjusted laterally relative to one another.

7. The side-shift assembly of claim 1, wherein the backplate, the first fork, and the second fork are capable of being independent adjusted laterally relative to one another.

8. A side-shift assembly for a forklift, comprising:
a carriage mounted on the forklift;
a backplate coupled to the carriage, the backplate capable of lateral adjustment relative to the carriage;
a backplate actuator coupled to the backplate, the backplate actuator configured to provide driving force to adjust the backplate;
a fork assembly mounted on the backplate, wherein the fork assembly includes a first fork and a second fork, each of the first fork and the second fork capable of independent lateral adjustment relative to the backplate;
a fork actuator coupled to the first fork and the second fork, the fork actuator configured to provide driving force to independently adjust the first fork and the second fork; and
a controller communicatively coupled to the backplate actuator and the fork actuator.

9. The side-shift assembly of claim 8, wherein the first fork and the second fork are mounted on a rail coupled to the backplate.

10. The side-shift assembly of claim 8, wherein the first fork is mounted on a first rail coupled to the backplate, and the second fork is mounted on a second rail coupled to the backplate.

11. The side-shift assembly of claim 8, wherein the fork actuator is selected from a group consisting of an electric actuator, a hydraulic actuator, a pneumatic actuator, a mechanical actuator, and an electromagnetic actuator.

12. The side-shift assembly of claim 8, further comprising a sensor module mounted on at least one of the first fork and the second fork.

13. The side-shift assembly of claim 8, further comprising a sensor module mounted on the carriage.

14. The side-shift assembly of claim 8, wherein each of the first fork and the second fork are capable of being independently adjusted laterally relative to one another.

15. A side-shift assembly for a forklift, comprising:
a carriage mounted on the forklift;
a backplate coupled to the carriage, the backplate capable of lateral adjustment relative to the carriage;
a backplate actuator coupled to the backplate, the backplate actuator configured to provide driving force to adjust the backplate;
a fork assembly mounted on the backplate, wherein the fork assembly includes a first fork and a second fork, each of the first fork and the second fork capable of independent lateral adjustment relative to the backplate, and each of the first fork and the second fork capable of independent lateral adjustment relative to one another;
a fork actuator coupled to the first fork and the second fork, the fork actuator configured to provide driving force to independently adjust the first fork and the second fork; and
a controller communicatively coupled to the backplate actuator and the fork actuator.

16. The side-shift assembly of claim 15, wherein the first fork and the second fork are mounted on a rail coupled to the backplate.

17. The side-shift assembly of claim 15, wherein the first fork is mounted on a first rail coupled to the backplate, and the second fork is mounted on a second rail coupled to the backplate.

18. The side-shift assembly of claim 15, wherein the fork actuator is selected from a group consisting of an electric actuator, a hydraulic actuator, a pneumatic actuator, a mechanical actuator, and an electromagnetic actuator.

19. The side-shift assembly of claim 15, wherein the backplate actuator is selected from a group consisting of an electric actuator, a hydraulic actuator, a pneumatic actuator, a mechanical actuator, and an electromagnetic actuator.

20. The side-shift assembly of claim 15, further comprising a sensor module mounted on the carriage.
